(19) United States
(12) Patent Application Publication
(10) Pub. No.: US 2024/0418580 A1
(43) Pub. Date: Dec. 19, 2024

(54) TEMPERATURE DETERMINATION DEVICE FOR POWER MODULE

(71) Applicants: Hyundai Motor Company, Seoul (KR); Kia Corporation, Seoul (KR)

(72) Inventors: Je Hwan LEE, Seongnam-si (KR); Yeong Ju KOH, Suncheon-si (KR)

(73) Assignees: Hyundai Motor Company, Seoul (KR); Kia Corporation, Seoul (KR)

(21) Appl. No.: 18/389,288

(22) Filed: Nov. 14, 2023

(30) Foreign Application Priority Data
Jun. 19, 2023 (KR) 10-2023-0078084

(51) Int. Cl. G01K 13/02; G01K 1/02

(52) U.S. Cl. CPC G01K 13/026; G01K 1/026

(57) ABSTRACT

Provided is a temperature determination device for a power module, including a water temperature estimation unit configured to determine a temperature increase in each of switching elements based on operation information of the switching elements and to determine an estimated temperature of cooling water based on an influence coefficient preset to correspond to each of remaining switching elements that are not provided with the first temperature sensor and the temperature increase, and a junction temperature determination unit configured to determine a junction temperature based on the estimated water temperature.

### CROSS-REFERENCE TO RELATED APPLICATION

The present application claims priority to Korean Patent Application No. 10-2023-0078084, filed on Jun. 19, 2023, the entire contents of which is incorporated herein for all purposes by this reference.

### BACKGROUND OF THE PRESENT DISCLOSURE

### Field of the Present Disclosure

The present disclosure relates to a temperature determination device for a power module for determining a junction temperature of the power module to protect the power module from over-temperature.

### Description of Related art

In general, one end of a winding of each of phases included in a motor is connected to one inverter and the other ends of the windings of the phases are connected to form a Y-connection.

When the motor is driven, a switching element in the inverter is turned ON/OFF by pulse width modulation control and applies a line voltage to the Y-connected windings of the motor to generate alternating current, generating torque.

Because the fuel efficiency of an eco-friendly vehicle such as an electric vehicle that utilizes the torque generated by such a motor as power is determined by the power conversion efficiency of the inverter-motor, it is important to maximize the power conversion efficiency of the inverter and the efficiency of the motor for fuel efficiency enhancement.

The efficiency of the inverter-motor system is mainly determined by a voltage utilization rate of the inverter. When an operating point of a vehicle determined by the relationship between the motor speed and torque is formed in a range where the voltage utilization rate is high, the fuel efficiency of the vehicle may be improved.

However, as the number of windings of the motor is increased to increase the maximum torque of the motor, a range with a high voltage utilization becomes farther away from a low torque region, which is a main operating point of the vehicle, and thus fuel efficiency may deteriorate. Furthermore, from the point of view of fuel efficiency, when the main operating point is designed to be included in a range with a high voltage utilization rate, the maximum torque of the motor is limited, which may cause a problem of deterioration of acceleration and start performance of the vehicle.

In the present field of the present disclosure, as motor driving technology capable of improving system efficiency while covering both low and high power ranges with one motor is required, technology for driving one motor in two different modes using two inverters and a mode switch has recently been introduced.

To implement such motor driving technology, a power module including a plurality of switching elements may be utilized. In a case in which such a power module operates at a high temperature, the power module may be damaged or the durability thereof may be reduced, and thus it is necessary to manage the power module so that the power module operates within a certain temperature range.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a temperature determination device for a power module, which can reduce the dependence of a water temperature sensor for measuring the temperature of cooling water for cooling the power module in determining a junction temperature of the power module, and determine the junction temperature even when direct junction temperature detecting for some switching elements is impossible.

The object of the present disclosure is not limited to the object mentioned above, and other objects not mentioned will be clearly understood by those skilled in the art from the following description.

In accordance with an aspect of the present disclosure, the above and other objects may be accomplished by the provision of a temperature determination device for a power module including a plurality of switching elements and a first temperature sensor provided in some of the plurality of switching elements and configured for measuring temperatures of the switching elements, the temperature determination device serving to predict a temperature of the power module cooled by cooling water, the temperature determination device including a water temperature estimation unit configured to determine a temperature increase in each of the switching elements based on operation information of the switching elements and to determine an estimated temperature of the cooling water based on an influence coefficient preset to correspond to each of remaining switching elements that are not provided with the first temperature sensor and the temperature increase, and a junction temperature determination unit configured to determine junction temperatures of at least one of the plurality of switching elements based on the estimated water temperature.

For example, the temperature increase may be determined based on power loss and thermal resistance according to operation of the power module.

For example, the influence coefficient may be preset based on experimental values with respect to a correlation between heat generation of the switching elements that are not provided with the first temperature sensor among the plurality of switching elements and a measurement result of the first temperature sensor.

For example, the junction temperature determination unit may be configured to determine the junction temperatures of the at least one of the plurality of switching elements in further consideration of a measurement result of a second temperature sensor for measuring a temperature of the cooling water.

For example, the plurality of switching elements may include a first switching element and a second switching element of different types, and a third switching element determining whether or not the second switching element will operate according to an ON/OFF state, the power module may include a first operation mode in which the first switching element operates with the third switching element turned on or a second operation mode in which the second switching element operates along with the first switching element with the third switching element turned off, and the water temperature estimation unit may be configured to determine the estimated water temperature according to one of the first and second operation modes.

For example, the first switching element may be implemented using silicon carbide (SiC).

For example, the first temperature sensor may be provided in the second switching element.

For example, the water temperature estimation unit may be configured to determine the estimated water temperature based on a first temperature increase and a first influence coefficient with respect to the first switching element and a third temperature increase and a third influence coefficient with respect to the third switching element in a case in which the operation mode of the power module is the first operation mode.

For example, the water temperature estimation unit may be configured to determine the estimated water temperature by subtracting a value obtained by reflecting the first influence coefficient in the first temperature increase and a value obtained by reflecting the third influence coefficient in the third temperature increase from the measurement result of the first temperature sensor.

For example, the junction temperature determination unit may be configured to determine a junction temperature of the first switching element based on the determined estimated water temperature and the first temperature increase and determine a junction temperature of the third switching element based on the determined estimated water temperature and the third temperature increase.

For example, the water temperature estimation unit may be configured to determine the estimated water temperature based on the first temperature increase and the first influence coefficient with respect to the first switching element and a second temperature increase with respect to the second switching element in a case in which the operation mode of the power module is the second operation mode.

For example, the water temperature estimation unit may be configured to determine the estimated water temperature by subtracting a value obtained by reflecting the first influence coefficient in the first temperature increase and the second temperature increase from the measurement result of the first temperature sensor.

For example, the junction temperature determination unit may be configured to determine the junction temperature of the first switching element based on the determined estimated water temperature and the first temperature increase.

For example, the junction temperature determination unit may be configured to determine a temperature according to the measurement result of the first temperature sensor as a junction temperature of the second switching element.

For example, the junction temperature determination unit may be configured to determine the junction temperature of the second switching element based on the determined estimated water temperature and the second temperature increase.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a circuit diagram of a motor driving device applicable to various exemplary embodiments of the present disclosure;

FIG. 2 is a diagram illustrating driving mode switching of the motor driving device applicable to various exemplary embodiments of the present disclosure;

FIG. 3 is a diagram illustrating a power module applicable to various exemplary embodiments of the present disclosure;

FIG. 4 is a circuit diagram of the power module applicable to various exemplary embodiments of the present disclosure;

FIG. 5 is a schematic diagram of a temperature determination device for a power module according to an exemplary embodiment of the present disclosure;

FIG. 6 is a diagram illustrating an operation mechanism of determining a junction temperature according to an exemplary embodiment of the present disclosure; and

FIG. 7A and FIG. 7B are diagrams for describing results of determining a junction temperature according to an exemplary embodiment of the present disclosure through comparison with a comparative example.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Specific structural or functional descriptions of embodiments of the present disclosure included in the present specification or application are merely illustrated for explaining the exemplary embodiments according to an exemplary embodiment of the present disclosure, and the exemplary embodiments of the present disclosure may be implemented in various forms and should not be construed as being limited to the exemplary embodiments described in the present specification or application.

Exemplary embodiments of the present disclosure may be modified in various manners and can have various forms, and thus specific embodiments are illustrated in the drawings and described in detail in the present specification or application. However, this is not intended to limit the exemplary embodiments according to the concept of the present disclosure to a specific included form, and should be understood to include all modifications, equivalents, or substitutes included in the spirit and scope of the present disclosure.

All terms including technical or scientific terms include the same meanings as generally understood by a person having ordinary skill in the art to which the present disclosure pertains unless mentioned otherwise. Generally used terms, such as terms defined in a dictionary, should be interpreted to coincide with meanings of the related art from the context. Unless differently defined in an exemplary embodiment of the present disclosure, such terms should not be interpreted in an ideal or excessively formal manner.

Hereinafter, various exemplary embodiments included in the present specification will be described in detail with reference to the accompanying drawings, but the same or similar components are denoted by the same reference numerals and redundant descriptions thereof will be omitted.

The suffixes “module” and “part” of elements herein are used for convenience of description and thus may be used interchangeably and do not have any distinguishable meanings or functions.

In the following description of the exemplary embodiments included in the present specification, a detailed description of known functions and configurations incorporated herein will be omitted when it may obscure the subject matter of the present disclosure. Furthermore, the accompanying drawings are provided only for ease of understanding of the exemplary embodiments included in the present specification, do not limit the technical spirit included herein, and include all changes, equivalents and substitutes included in the spirit and scope of the present disclosure.

The terms “first” and/or “second” are used to describe various components, but such components are not limited by these terms. The terms are used to discriminate one component from another component.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

An element described in the singular form is directed to include a plurality of elements unless the context clearly indicates otherwise.

In the present specification, it will be further understood that the term “comprise” or “include” specifies the presence of a stated feature, figure, step, operation, component, part or combination thereof, but does not preclude the presence or addition of one or more other features, figures, steps, operations, components, or combinations thereof.

Furthermore, a unit or a control unit included in the names of a motor control unit (MCU), a hybrid control unit (HCU), and the like is only a term widely used to name a controller that is configured to control a specific vehicle function and does not mean a generic functional unit.

A controller may include a communication device that communicates with other controllers or sensors to control functions of the controller, a memory that stores an operating system or logic commands and input/output information, and one or more processors that perform determination, operation, and decision necessary to control the functions.

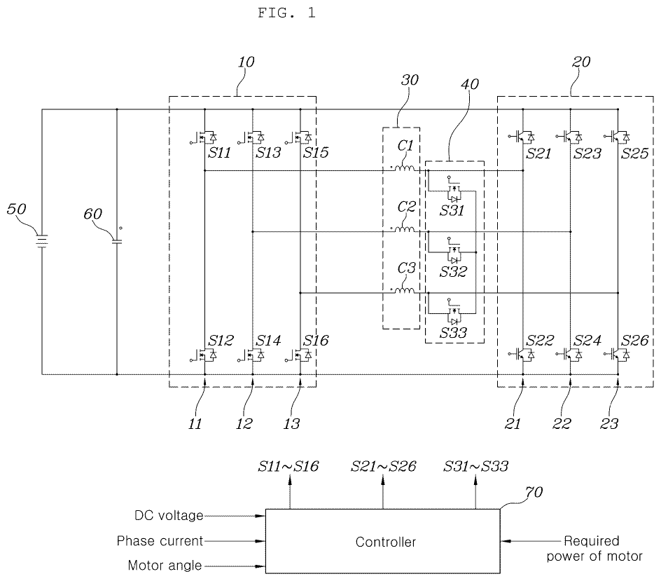

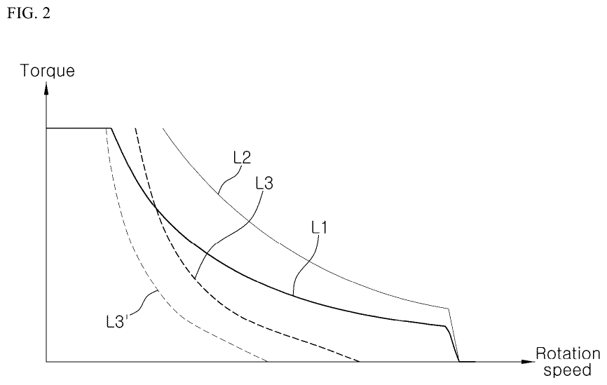

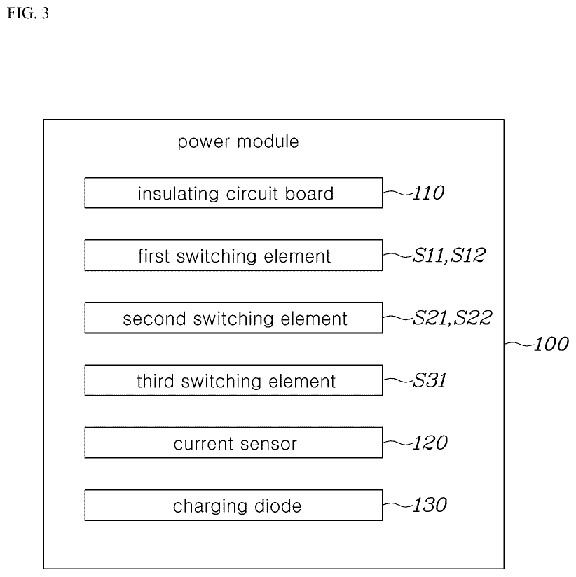

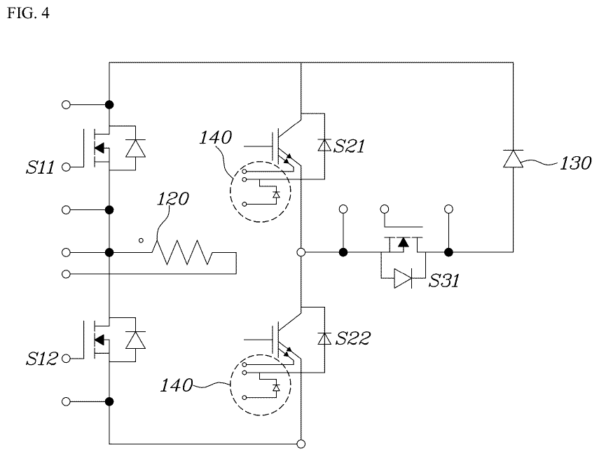

Prior to describing a temperature determination device for a power module according to an exemplary embodiment of the present disclosure, a motor driving device and a power module applicable to the exemplary embodiments of the present disclosure will be first described with reference to FIG. 1, FIG. 2, FIG. 3, and FIG. 4.

FIG. 1 is a circuit diagram of a motor driving device applicable to various exemplary embodiments of the present disclosure.

Referring to FIG. 1, the motor driving device according to various exemplary embodiments of the present disclosure may include a first inverter 10, a second inverter 20, and a motor 30 including a plurality of windings C1, C2, and C3 respectively corresponding to a plurality of phases, a mode switching unit 40, a battery 50, a DC capacitor (or DC-link capacitor) 60, and a controller 70.

The first inverter 10 may include a plurality of first switching elements S11, S12, S13, S14, S15 and S16 connected to one end of each of the windings C1, C2, and C3, and the second inverter 20 may include a plurality of second switching elements S21, S22, S23, S24, S25 and S26 connected to the other end of each of the windings C1, C2, and C3. The mode switching unit 40 may include a plurality of mode switches S31, S32 and S33 connected between the other end of each of the windings C1, C2, and C3 and the neutral end of the plurality of windings C1, C2, and C3. The controller 70 may be configured for controlling ON/OFF states of the first switching elements S11, S12, S13, S14, S15, and S16, the second switching elements S21, S22, S23, S24, S25, and S26, and the mode switches S31, S32, and S33 based on required power of a motor (i.e., a torque command for the motor), a DC link voltage of the inverters 10 and 20 (i.e., the voltage of the battery), and the phase current of the motor, and the motor angle.

The first inverter 10 may include a plurality of legs 11, 12, and 13 to which a DC voltage formed in the DC capacitor 60 connected between both ends of the battery 50 is applied. The legs 11, 12, and 13 correspond to the plurality of phases of the motor 30, and thus electrical connections may be formed.

The first leg 11 may include two switching elements S11 and S12 connected in series between both ends of the DC capacitor 60, and the connection node of the two switching elements S11 and S12 may be connected to one end of the winding C1 of one phase in the motor 30 so that AC power corresponding to one phase is input and output. Similarly, the second leg 12 may include two switching elements S13 and S14 connected in series between both ends of the DC capacitor 60, and the connection node of the two switching elements S13 and S14 may be connected to one end of the winding C2 of one phase in the motor 30 so that AC power corresponding to one phase is input and output. Furthermore, the third leg 13 may include two switching elements S15 and S16 connected in series between both ends of the DC capacitor 60, and the connection node of the two switching elements S15 and S16 may be connected to one end of the winding C3 of one phase in the motor 30 so that AC power corresponding to one phase is input and output.

The second inverter 20 may include a plurality of legs 21, 22, and 23 to which the DC voltage formed in the DC capacitor 60 connected between both ends of the battery 50 is applied. The legs 21, 22, and 23 may correspond to the plurality of phases of the motor 30, and thus electrical connections may be formed.

The first leg 21 includes two switching elements S21 and S22 connected in series between both ends of the DC capacitor 60, and the connection node of the two switching elements S21 and S22 may be connected to the other end of the winding C1 of one phase in the motor 30 so that AC power corresponding to one phase is input and output. Similarly, the second leg 22 includes two switching elements S23 and S24 connected in series between both ends of the DC capacitor 60, and the connection node of the two switching elements S23 and S24 may be connected to the other end of the winding C2 of one phase in the motor 30 so that AC power corresponding to one phase is input and output. Furthermore, the third leg 23 includes two switching elements S25 and S26 connected in series between both ends of the DC capacitor 60, and the connection node of the two switching elements S25 and S26 may be connected to the other end of the winding C3 of one phase in the motor 30 so that AC power corresponding to one phase is input and output.

One end of each of the mode switches S31, S32, and S33 may be connected to the other end of each of the windings C1, C2, and C3 included in the motor 30, and the other ends of the mode switches S31, S32, and S33 may be connected to each other at the neutral end of the motor 30. The plurality of mode switches S31, S32, and S33 may employ various switching means known in the art, such as a MOSFET, an IGBT, a thyristor, a relay, and the like.

Although not shown in FIG. 1, the motor driving device may further include so-called a Y-capacitor (Y-Cap) in which two capacitors are connected in series between a positive (+) DC terminal and a negative (−) DC terminal and the connection node between the capacitors is grounded.

The controller 70 may be configured for controlling the motor 30 so that the motor 30 operates by switching the switching elements S11, S12, S13, S14, S15, S16, S21, S22, S23, S24, S25, and S26 included in the first inverter 10 and the second inverter 20 through pulse width modulation control based on the required power of the motor 30.

Furthermore, the controller 70 may be configured for controlling ON/OFF states of the third switching elements S31, S32, and S33 included in the mode switching unit 40 according to a motor driving mode. The motor driving mode may include a first driving mode and a second driving mode. In the instant case, the first driving mode may be referred to as a “closed end winding (CEW) mode” and the second driving mode may be referred to as an “open end winding (OEW) mode”.

The controller 70 may be configured for controlling the mode switches S31, S32, and S33 so that they are in an ON state and drive the motor 30 through the first inverter 10 in the CEW mode. The mode switches S31, S32, and S33 may electrically connect the other end of each of the windings C1 to C3 and the neutral end of the plurality of windings C1 to C3 in the ON state.

In the OEW mode, the controller 70 may be configured for controlling the mode switches S31, S32, and S33 so that they are in an OFF state and drive the motor 30 through the two inverters 10 and 20. The mode switches S31, S32, and S33 may electrically separate the other end of each of the windings C1 to C3 and the neutral end of the plurality of windings C1 to C3 in the OFF state.

FIG. 2 is a diagram illustrating switching between driving modes of the motor driving device applicable to various exemplary embodiments of the present disclosure.

FIG. 2 shows a motor operating point map in which an output limitation curve L1 of the CEW mode, an output limitation curve L2 of the OEW mode, and a mode switching reference line L3 based on an efficiency map are indicated.

The output limitation curves L1 and L2 may represent output torque limitation values of the motor for each rotation speed (e.g., RPM) of the motor in the respective motor driving modes. The output limitation curve L2 includes an output limit greater than the output limitation curve L1 in at least a part of revolutions per minute (rpm) region, and the output limitation curves L1 and L2 may be set in consideration of durability, heat generation, and current controllability of the motor and the inverters.

The mode switching reference line L3 based on the efficiency map may correspond to a boundary line between a high efficiency region of the CEW mode and a high efficiency region of the OEW mode. The efficiency map includes information on a mode with higher efficiency between the CEW mode and the OEW mode in each combination of the torque and reverse magnetic flux of the motor, and may include a table form depending on the implementation. For example, the efficiency map may be derived based on results of measuring motor loss according to the rotation speed and torque of the motor in each motor driving mode for each DC link voltage of an inverter through tests. Here, the reverse magnetic flux of the motor may be inversely proportional to the DC link voltage of the inverter (i.e., the voltage of the battery) and may be proportional to the speed of the motor.

According to the exemplary embodiment of the present disclosure, the mode switching reference line L3 may include a shape such as L3′ according to the specifications of the motor driving device. However, the mode switching reference lines L3 and L3′ shown in FIG. 2 are exemplary and are not necessarily limited thereto.

To switch the motor driving mode according to the mode switching reference line L3, the controller 70 may switch the CEW mode and the OEW mode in both directions according to a torque command value and a reverse magnetic flux value with respect to the motor with reference to the efficiency map. In the instant case, the reverse magnetic flux value may be determined based on a torque command for the motor, a DC link voltage of the inverter, and a required speed of the motor. According to the exemplary embodiment of the present disclosure, the controller 70 may correct the mode switching reference line in consideration of output limitation or hysteresis for motor driving modes, and in the instant case, can switch between mode driving modes according to the torque command value and the reverse magnetic flux value with respect to the motor based on the corrected mode switching reference line.

The motor driving device applicable to the exemplary embodiments of the present disclosure described with reference to FIG. 1 and FIG. 2 may be configured through a combination of power modules including a plurality of switching elements. For example, when one leg of each of the inverters 10 and 20 and one switching element forming the mode switching unit 40 are disposed in one power module, the motor driving device may be configured using three power modules configured in the present manner. This will be described with reference to FIG. 3 and FIG. 4.

FIG. 3 is a diagram illustrating a power module applicable to the exemplary embodiments of the present disclosure, and FIG. 4 is a circuit diagram of the power module shown in FIG. 3.

Referring to FIG. 3 and FIG. 4, the power module 100 applicable to the exemplary embodiments of the present disclosure may include an insulating circuit board 110, a pair of first switching elements S11 and S12, a pair of second switching elements S21 and S22, and one third switching element S31, and additionally include a current sensor 120, a charging diode 130, and the like.

First, the first switching elements S11 and S12 may form one leg of the first inverter 10 in the motor driving device described with reference to FIG. 1 and FIG. 2, and the second switching element S21 and S22 may form one leg of the second inverter 20 in the motor driving device described with reference to FIG. 1 and FIG. 2. The third switching element S31 may form the mode switching unit in the motor driving device described with reference to FIG. 1 and FIG. 2.

The plurality of switching elements S11, S12, S21, S22, and S31 may be disposed on the insulating circuit board 110, and the power module 100 applicable to the exemplary embodiments of the present disclosure may be implemented so that the switching elements S11, S12, S21, S22, and S31 are disposed on one insulating circuit board 110, or the switching elements S11, S12, S21, S22, and S31 are disposed between a plurality of insulating circuit boards 110.

Although not shown, a cooling channel may be provided outside the power module 100, and the power module 100 may be cooled by cooling water flowing inside the cooling channel.

Meanwhile, these switching elements S11, S12, S21, S22, and S31 may be implemented through at least one semiconductor chip. For example, each switching element of the pair of first switching elements S11 and S12 may be implemented using two semiconductor chips. On the other hand, each of the switching elements of the pair of second switching elements S21 and S22 and the third switching element S31 may be implemented using one semiconductor chip.

In a case in which each switching element is implemented using a plurality of semiconductor chips, such as the switching elements S11 and S12, the size of each semiconductor chip and output performance may be reduced when the same required power is assumed. Therefore, in a case in which there is a restriction (e.g., high cost) on implementation of a switching element using a single semiconductor chip having high output performance, a method of implementing a switching element through a combination of a plurality of semiconductor chips may be utilized.

Semiconductor chips for implementing the switching elements S11, S12, S21, S22, and S31 may be implemented using an insulated gate bipolar transistor (IGBT), a metal oxide semiconductor field effect transistor (MOSFET), or the like, and silicon (Si) or silicon carbide (SiC) may be used as a material thereof.

The first switching elements S11 and S12, the second switching elements S21 and S22, and the third switching element S31 may be implemented as different types of switching elements, and only some switching elements may be provided with a first temperature sensor 140 for measuring a junction temperature.

In a case in which the first temperature sensor 140 is provided in all of the switching elements S11, S12, S21, S22, and S31, the temperature of each of the switching elements S11, S12, S21, S22, and S31 may be measured more simply and accurately, and thus it is easy to achieve over-temperature protection for the power module 100.

However, in a case in which the first temperature sensor 140 is provided in all the switching elements S11, S12, S21, S22, and S31, an additional space for disposing additional first temperature sensors 140, signal pins for connection of the first temperature sensors 140, and the like is required, which is disadvantageous to miniaturization of the module and increases the cost.

Therefore, instead of providing the first temperature sensor 140 in all the switching elements S11, S12, S21, S22, and S31 in the power module 100, the first temperature sensor 140 may be provided in only some switching elements S21 and S22, and switching elements S11, S12, S21, S22, and S31 in which the first temperature sensor 140 will be provided may be determined in relation to the characteristics of the switching elements S11, S12, S21, S22, and S31.

Some of the first switching elements S11 and S12, the second switching elements S21 and S22, and the third switching element S31 may be implemented as the same type and some may be implemented as different types, and whether or not the first temperature sensor 140 is provided may depend on the type of each of the switching elements S11, S12, S21, S22, and S31.

Because the first switching elements S11 and S12 can always operate when the motor is driven, high-performance output specifications are required therefor compared to the second switching elements S21 and S22. To the present end, the first switching elements S11 and S12 may be implemented using SiC. In a case in which the first switching elements S11 and S12 are implemented using SiC, the cost is very high as compared to a case in which the first switching elements S11 and S12 are implemented using IGBT or the like, and it is difficult to provide a space for mounting the first temperature sensor 140 thereon.

On the other hand, because the second switching elements S21 and S22 can operate together with the first switching elements S11 and S12 when the motor operates in a high power mode, required power specifications may be lower than those for the first switching elements S11 and S12. Therefore, unlike the first switching elements S11 and S12, the second switching elements S21 and S22 are less burdensome in mounting the first temperature sensor 140, and may be implemented using, for example, an IGBT.

However, unlike the above description, the power module 100 applicable to the exemplary embodiments of the present disclosure may include a single type of switching elements, and even if switching elements of the same type are provided, whether or not the first temperature sensor 140 is provided may be different for the switching elements.

A temperature determination device 200 for the power module according to an exemplary embodiment of the present disclosure is configured to determine the temperatures of the plurality of switching elements S11, S12, S21, S22, and S31 through the first temperature sensor 140 provided in some of the plurality of switching elements S11, S12, S21, S22, and S31 as described above, and thus it is possible to improve the accuracy of junction temperature determination while increasing the efficiency of junction temperature determination.

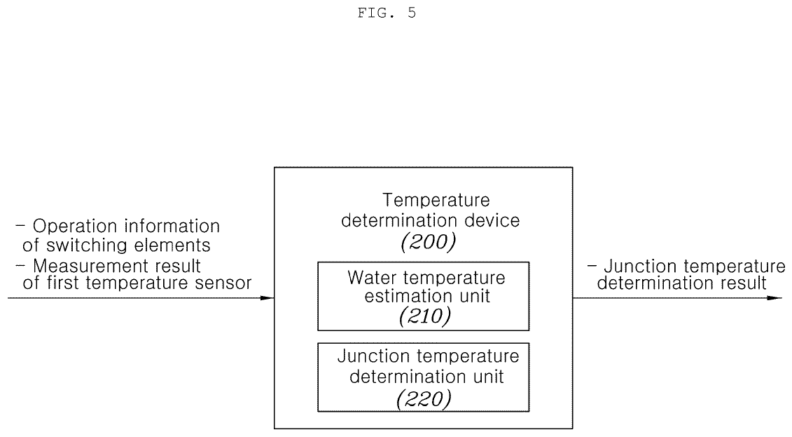

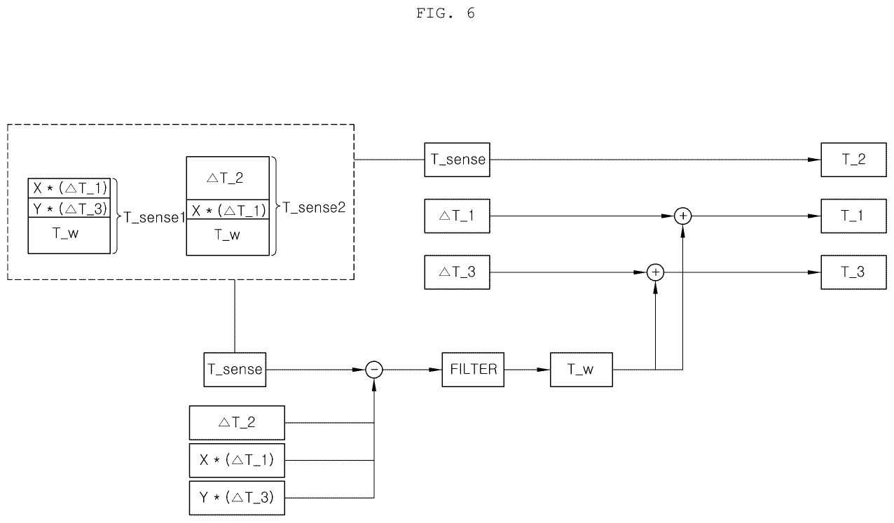

Hereinafter, the temperature determination device 200 for the power module according to an exemplary embodiment of the present disclosure will be described in detail with reference to FIG. 5 and FIG. 6.

FIG. 5 is a schematic diagram of the temperature determination device for a power module according to an exemplary embodiment of the present disclosure.

Referring to FIG. 5, the temperature determination device 200 for the power module according to an exemplary embodiment of the present disclosure is configured to predict the temperature of the power module 100, and includes a water temperature estimation unit 210 and a junction temperature determination unit 220, receives operation information of the switching elements S11, S12, S21, S22, and S31, measurement results of the first temperature sensor 140, and the like, and outputs a junction temperature determination result.

Here, the power module 100 includes the plurality of switching elements S11, S12, S21, S22, and S31 and the first temperature sensor 140 provided in some of the plurality of switching elements to measure a junction temperature of the switching elements, and may be cooled by cooling water.

The operation information of the switching elements S11, S12, S21, S22, and S31 input to the temperature determination device 200 may be used to determine temperature changes due to heat generation of the switching elements S11, S12, S21, S22, and S31 and may include, for example, whether the switching elements S11, S12, S21, S22, and S31 operate, a load current, an input voltage, a variable frequency, and the like. The operation information of the switching elements S11, S12, S21, S22, and S31 may be information on each of the switching elements S11, S12, S21, S22, and S31 included in the power module 100.

Furthermore, the temperature determination device 200 may have measurement results of the first temperature sensor 140 as input thereof information, and the measurement results of the first temperature sensor 140 may be used to estimate a water temperature and determine a junction temperature.

Based on the input information described above, the temperature determination device 200 according to an exemplary embodiment of the present disclosure may be configured to determine the junction temperature of the power module 100 and include a determination result as an output information. The output determination result may be used for over-temperature protection control of the power module 100.

The aforementioned input information may be obtained from a controller that is configured to control the power module 100 or a higher controller thereof, and the aforementioned output information may be transmitted to the controller. To the present end, the temperature determination device 200 according to an exemplary embodiment of the present disclosure may be connected to the controller that is configured to control the power module 100 or may be implemented as a function of the controller.

Meanwhile, the water temperature estimation unit 210 may be configured to determine a temperature increase in each of the switching elements S11, S12, S21, S22, and S31 based on the operation information of the switching elements S11, S12, S21, S22, and S31.

In the instant case, the temperature increase may be determined based on power loss and thermal resistance according to operation of the power module.

Power loss according to the operation of the power module 100 may occur during operations of the switching elements S11, S12, S21, S22, and S31 and the charging diode and may include a conduction loss generated when current flowing through the switching elements and the charging diode 130 passes through a resistor and a switching loss generated according to the switching operation.

The conduction loss and switching loss of the switching elements S11, S12, S21, S22, and S31 and the charging diode 130 may be determined based on the input load current, input voltage, variable frequency, and the like.

The thermal resistance according to the operation of the power module 100 may be determined according to the unique characteristics of the power module 100 and the heat dissipation characteristics of the cooler connected to the power module 100, and determined based on the input load current, input voltage, variable frequency, and the like.

Furthermore, the water temperature estimation unit 210 may be configured to determine an estimated water temperature of the cooling water based on the determined temperature increase and an influence coefficient preset to correspond to the switching elements which are not provided with the first temperature sensor among the plurality of switching elements 11, S12, S21, S22, and S31.

In the instant case, the influence coefficient may be set based on experimental values with respect to a correlation between heat generation of the switching elements which are not provided with the first temperature sensor among the plurality of switching elements S11, S12, S21, S22, and S31 and a measurement result of the first temperature sensor 140.

The measurement result of the first temperature sensor 140 may be affected not only by switching elements provided with the first temperature sensor 140, but also by heat generation of switching elements which are not provided with the first temperature sensor 140. Furthermore, heat generation of the charging diode 130 may also affect the measurement result of the first temperature sensor 140.

For example, when the plurality of switching elements S11, S12, S21, S22, and S31 includes the first switching elements S11 and S12, the second switching elements S21 and S21, and the third switching element S31, and the first temperature sensor 140 is provided only in the second switching elements S21 and S22, the vicinity of the first temperature sensor 140 may be directly heated due to heat generation of the second switching elements S21 and S22 and may also be indirectly heated due to heat generation of the first switching elements S11 and S12 and the third switching element S31. Furthermore, the vicinity of the first temperature sensor 140 may be heated due to heat generation of the charging diode 130. In the instant case, a degree of contribution of each of the switching elements S11, S12, S21, S22, and S31 or the charging diode 130 to the temperature of the vicinity of the first temperature sensor 140 measured through the first temperature sensor 140 may be determined and the influence coefficient may be set depending thereon.

By reflecting the mutual influence due to heat generation of the switching elements S11, S12, S21, S22, and S31 in estimation of the water temperature and determination of the junction temperature in the present manner, it is possible to determine even the junction temperature of switching elements that are not provided with the first temperature sensor 140 through the first temperature sensor 140 provided only in some switching elements.

Meanwhile, the junction temperature determination unit 220 may be configured to determine the junction temperature of at least some of the plurality of switching elements S11, S12, S21, S22, and S31 based on the estimated water temperature of the coolant determined by the water temperature estimation unit 210.

The junction temperature determination unit 220 may be configured to determine a final junction temperature based on the temperature increase determined by the water temperature estimation unit 210 and the estimated water temperature. Because the estimated water temperature can represent the temperature in the vicinity of the switching elements S11, S12, S21, S22, and S31, the value obtained by adding the temperature increase to the estimated water temperature may be determined as the junction temperature of the switching elements S11, S12, S21, S22, and S31.

In the case of a switching element provided with the first temperature sensor 140, the measurement result of the first temperature sensor 140 itself may represent the junction temperature of the switching element, and thus it is possible to determine the measurement result of the first temperature sensor 140 itself as the junction temperature of the switching element instead of using the estimated water temperature as described above.

Furthermore, although not essential, the junction temperature determination unit 220 may be configured to determine a junction temperature by further considering a measurement result of a second temperature sensor for measuring the temperature of cooling water. In the instant case, a junction temperature may be determined by adding a temperature increase to a measurement result of the second temperature sensor if a water temperature measured by the second temperature sensor may be used to determine the junction temperature, and the junction temperature may be determined using an estimated water temperature if not.

The plurality of switching elements S11, S12, S21, S22, and S31 provided in the power module 100 may be divided into different types of first switching elements S11 and S12 and second switching elements S21 and S22, and the third switching element S31 that is configured to determine whether the second switching elements S21 and S22 will operate according to an ON/OFF state.

In the instant case, the power module 100 may operate in different operation modes according to the ON/OFF state of the third switching element S31. The operation modes of the power module 100 may include a first operation mode in which the first switching elements S11 and S12 operate with the third switching element S31 turned on, and a second operation mode in which the second switching elements S21 and S22 operate together with the first switching elements S11 and S12 with the third switching element S31 turned off.

Here, the first operation mode is for driving the aforementioned motor driving device in a first driving mode (i.e., CEW mode), and the second operation mode is for driving the aforementioned motor driving device in a second driving mode (i.e., OEW mode).

In the instant case, the water temperature estimation unit 210 may be configured to determine an estimated water temperature according to the first and second operation modes of the power module 100. Because the operation of each of the switching elements S11, S12, S21, S22 and S31 is different depending on the operation mode of the power module 100, it is possible to improve the accuracy and usability of temperature determination by reflecting the operation mode in the estimated water temperature and junction temperature determination.

Furthermore, the first switching elements S11 and S12 and the second switching elements S21 and S22 may be configured as different types of switching elements according to the driving mode of the motor driving device and the operation mode of the power module 100 as described above. For example, as described above, the first switching elements S11 and S12 may be implemented using SiC, and the second switching elements S21 and S22 may be implemented using an IGBT. Furthermore, the third switching element S31 may be implemented using SiC like the first switching elements S11 and S12.

In the instant case, the first temperature sensor 140 may be provided only in the second switching elements S21 and S22 that are relatively inexpensive and are advantageous in preparing a space for the sensor.

According to an exemplary embodiment of the present disclosure, the temperature determination device 200 may be a processor (e.g., computer, microprocessor, CPU, ASIC, circuitry, logic circuits, etc.) to execute the program(s), software instructions reproducing algorithms, etc.

Alternatively, each of the water temperature estimation unit 210 and the junction temperature determination unit 220 may be a processor (e.g. computer, microprocessor. CPU, ASIC, circuitry, logic circuits, etc.) to execute the program(s), software instructions reproducing algorithms. etc.

Hereinafter, a temperature determination process for the power module 100 configured as above will be described in detail with reference to FIG. 6.

FIG. 6 is a diagram illustrating an operation mechanism of determining a junction temperature according to an exemplary embodiment of the present disclosure.

FIG. 6 illustrates a process of determining a junction temperature T_1 of the first switching element S11 and S12, a junction temperature T_2 of the second switching elements S21 and S22, and a junction temperature T_3 of the third switching element S31.

A measurement result T_sense of the first temperature sensor 140 may be represented differently according to the operation mode of the power module 100, and as shown in FIG. 6, the measurement result may be represented as T_sense1 in the case of the first operation mode and T_sense2 in the case of the second operation mode.

Hereinafter, a temperature determination process in a case in which the operation mode of the power module 100 applicable to the exemplary embodiments of the present disclosure is the first operation mode will be described first.

The water temperature estimation unit 210 may be configured to determine an estimated water temperature based on a first temperature increase ΔT_1 and a first influence coefficient X with respect to the first switching elements S11 and S12 and a third temperature increase ΔT_3 and a third influence coefficient Y with respect to the third switching element S31.

For example, the water temperature estimation unit 210 may be configured to determine an estimated water temperature T_w by subtracting a value obtained by reflecting the first influence coefficient X in the first temperature increase ΔT_1 and a value obtained by reflecting the third influence coefficient Y in the third temperature increase ΔT_3 from the measurement result T_sense1 of the first temperature sensor 140 provided in the second switching elements S21 and S22.

That is, the estimated water temperature T_w may be determined by the following formula.

$$T\_w = T\_sense1 - ( X * ΔT\_ 1 + Y * ΔT\_ 3 )$$

Furthermore, the water temperature estimation process may be accompanied by filtering, and the value derived by the above formula may be determined as a final estimated water temperature through filtering.

The junction temperature determination unit 220 may be configured to determine the junction temperature T_1 of the first switching elements S11 and S12 based on the estimated water temperature T_w determined as above and the first temperature increase ΔT_1, or determine the junction temperature T_3 of the third switching element S31 based on the determined estimated temperature T_w and the third temperature increase ΔT_3.

For example, the junction temperature T_1 of the first switching elements S11 and S12 may be determined as a value obtained by adding the first temperature increase ΔT_1 to the estimated water temperature T_w, and the junction temperature T_3 of the third switching element S31 may be determined as a value obtained by adding the third temperature increase ΔT_3 to the estimated water temperature T_w.

That is, the junction temperatures of the first switching elements S11 and S12 and the third switching element S31 may be determined by the following formulas.

$$T\_ 1 = ΔT\_ 1 + T\_w$$

$$T\_ 3 = ΔT\_ 3 + T\_w$$

In a case in which the power module 100 applicable to the exemplary embodiments of the present disclosure operates in the second operation mode, the water temperature estimation unit 210 may be configured to determine an estimated water temperature T_w based on the first temperature increase ΔT_1 and the first influence coefficient X with respect to the first switching elements S11 and S12, and a second temperature increase ΔT_2 with respect to the second switching elements S21 and S22. Here, because the second switching elements S21 and S22 are measurement targets of the first temperature sensor 140 and heat sources generating heat, no influence coefficient is reflected in the second switching elements S21 and S22 and the second temperature increase ΔT_2 may be directly reflected in determining the estimated water temperature T_w.

For example, the water temperature estimation unit 210 may be configured to determine the estimated water temperature T_w by subtracting the value X*ΔT_1 obtained by reflecting the first influence coefficient X in the first temperature increase ΔT_1 and the second temperature increase ΔT_2 from the measurement result T_sense2 of the first temperature sensor 140 provided in the second switching elements S21 and S22.

That is, the estimated water temperature T_w may be determined by the following formula.

$$T\_w = T\_sense2 - ( X * ΔT\_ 1 + ΔT\_ 2 )$$

Furthermore, the water temperature estimation process may be accompanied by filtering, and the value derived by the above formula may be determined as a final estimated water temperature through filtering.

The junction temperature determination unit 220 may be configured to determine the junction temperature of the first switching elements S11 and S12 based on the estimated water temperature T_w determined as above and the first temperature increase ΔT_1, or determine the junction temperature of the second switching elements S21 and S22 based on the determined estimated water temperature T_w and the second temperature increase ΔT_2.

For example, the junction temperature T_1 of the first switching elements S11 and S12 may be determined as a value obtained by adding the first temperature increase ΔT_1 to the estimated water temperature T_w, and the junction temperature of the second switching elements S21 and S22 may be determined as a value obtained by adding the second temperature increase ΔT_2 to the estimated water temperature T_w.

That is, the junction temperatures of the first switching elements S11 and S12 and the second switching elements S21 and S22 may be determined by the following formulas.

$$T\_ 1 = ΔT\_ 1 + T\_w$$

$$T\_ 2 = ΔT\_ 2 + T\_w$$

Furthermore, because the first temperature sensor 140 is provided in the second switching elements S21 and S22, the junction temperature T_2 of the second switching elements S21 and S22 may be determined to be the same as the measurement result T_sense2 of the first temperature sensor 140 (i.e., T_2=T_sense2).

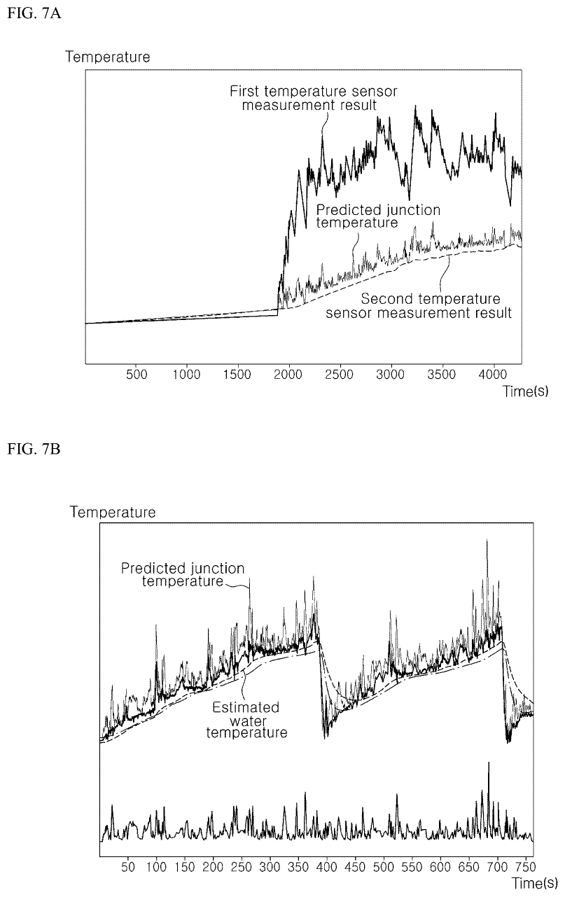

Hereinafter, results of junction temperature determination of the temperature determination device for the power module according to an exemplary embodiment of the present disclosure will be described with reference to FIG. 7A and FIG. 7B.

FIG. 7A and FIG. 7B are diagrams for describing results of determining a junction temperature according to an exemplary embodiment of the present disclosure through comparison with a comparative example.

FIG. 7A and FIG. 7B are graphs showing junction temperature determination results in a cooling water non-operating section (e.g., EWP non-operation), in which the horizontal axis represents time and the vertical axis represents temperature.

First, FIG. 7A shows results of determining a junction temperature through a second water temperature sensor for measuring the temperature of the cooling water without applying temperature determination according to an exemplary embodiment of the present disclosure.

In the instant case, because the water temperature measured through the second temperature sensor cannot represent the temperature of any switching element under cooling water non-operating conditions, a result measured through the first temperature sensor 140 and a predicted junction temperature based on the measured water temperature may be inconsistent.

Accordingly, even in a case in which an over-temperature protection operation is actually required due to high heat generation, a predicted junction temperature is derived as a low value and thus the over-temperature protection operation may not be performed.

On the other hand, FIG. 7B shows results of determining a junction temperature through an estimated water temperature by applying temperature determination according to an exemplary embodiment of the present disclosure.

In the instant case, unlike in FIG. 7A, because the estimated water temperature is used instead of a water temperature measured through the second temperature sensor, the temperature on the switching element side, that is, the temperature near a heat sink, may be reflected relatively accurately in determining the junction temperature, and the junction temperature may be determined relatively accurately even under cooling water non-operating conditions.

Because the second water temperature sensor typically measures the temperature of the cooling water flowing into the power module 100, there is a difference from the actual temperature of the switching element. However, an estimated water temperature according to an exemplary embodiment of the present disclosure is determined in consideration of heat generation of the switching elements S11, S12, S21, S22, and S31, and thus the actual temperatures of the switching elements may be indicated relatively accurately

Accordingly, the over-temperature protection operation may be performed at a relatively accurate point in time, and unlike the comparative example of FIG. 7A in which over-temperature protection is not performed even when the actual temperature is high, it is possible to check whether a predicted junction temperature exceeds a reference temperature and thus the over-temperature protection operation may be performed (section of 350 to 400 on the horizontal axis of FIG. 7B).

As described above, according to various embodiments of the present disclosure, the dependency on the water temperature sensor for detecting the temperature of cooling water in a process of determining a junction temperature may be alleviated by determining the junction temperature of the power module through an estimated water temperature. Accordingly, it is possible to omit the arrangement of the water temperature sensor and the connector for connecting the water temperature sensor, reducing cost and simplifying the circuit.

Furthermore, the accuracy of determination of the junction temperature may be improved using the estimated water temperature, and thus the normal operation range of the over-temperature protection for the power module may be extended.

Furthermore, even when all switching elements are not provided with a sensor for detecting the junction temperature, it is possible to determine the junction temperature for all switching elements, and thus the over-temperature protection performance of the power module may be improved.

Effects which may be obtained in an exemplary embodiment of the present disclosure are not limited to the effects mentioned above, and other effects not mentioned may be clearly understood by those skilled in the art from the description below.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A temperature determination apparatus for a power module including a plurality of switching elements and a first temperature sensor provided in some of the plurality of switching elements and configured for measuring temperatures of the switching elements, the temperature determination apparatus serving to predict a temperature of the power module cooled by cooling water, the temperature determination apparatus comprising:
a water temperature estimation unit configured to determine a temperature increase in each of the switching elements based on operation information of the switching elements and to determine an estimated temperature of the cooling water based on an influence coefficient preset to correspond to each of remaining switching elements that are not provided with the first temperature sensor and the temperature increase; and
a junction temperature determination unit configured to determine junction temperatures of at least one of the plurality of switching elements based on the estimated water temperature.

2. The temperature determination apparatus of claim 1, wherein the temperature increase is determined based on power loss and thermal resistance according to operation of the power module.

3. The temperature determination apparatus of claim 1, wherein the influence coefficient is preset based on experimental values with respect to a correlation between heat generation of the switching elements that are not provided with the first temperature sensor among the plurality of switching elements and a measurement result of the first temperature sensor.

4. The temperature determination apparatus of claim 1, wherein the junction temperature determination unit is configured to determine the junction temperatures of the at least one of the plurality of switching elements in further consideration of a measurement result of a second temperature sensor configured for measuring a temperature of the cooling water.

5. The temperature determination apparatus of claim 1, wherein the plurality of switching elements includes a first switching element and a second switching element of different types, and a third switching element determining whether the second switching element will operate according to an ON/OFF state,
the power module includes a first operation mode in which the first switching element operates with the third switching element turned on or a second operation mode in which the second switching element operates along with the first switching element with the third switching element turned off, and
the water temperature estimation unit is configured to determine the estimated water temperature according to an operation mode among the first and second operation modes.

6. The temperature determination apparatus of claim 5, wherein the first switching element is implemented using silicon carbide (SiC).

7. The temperature determination apparatus of claim 6, wherein the first temperature sensor is provided in the second switching element.

8. The temperature determination apparatus of claim 5, wherein the water temperature estimation unit is configured to determine the estimated water temperature based on a first temperature increase and a first influence coefficient with respect to the first switching element and a third temperature increase and a third influence coefficient with respect to the third switching element, in response that the operation mode of the power module is the first operation mode.

9. The temperature determination apparatus of claim 8, wherein the water temperature estimation unit is configured to determine the estimated water temperature by subtracting a value obtained by reflecting the first influence coefficient in the first temperature increase and a value obtained by reflecting the third influence coefficient in the third temperature increase from a measurement result of the first temperature sensor.

10. The temperature determination apparatus of claim 8, wherein the junction temperature determination unit is configured to determine a junction temperature of the first switching element based on the determined estimated water temperature among the junction temperatures and the first temperature increase and is configured to determine a junction temperature of the third switching element among the junction temperatures based on the determined estimated water temperature and the third temperature increase.

11. The temperature determination apparatus of claim 5, wherein the water temperature estimation unit is configured to determine the estimated water temperature based on a first temperature increase and a first influence coefficient with respect to the first switching element and a second temperature increase with respect to the second switching element in response that the operation mode of the power module is the second operation mode.

12. The temperature determination apparatus of claim 11, wherein the water temperature estimation unit is configured to determine the estimated water temperature by subtracting a value obtained by reflecting the first influence coefficient in the first temperature increase and the second temperature increase from a measurement result of the first temperature sensor.

13. The temperature determination apparatus of claim 11, wherein the junction temperature determination unit is configured to determine a junction temperature of the first switching element based on the determined estimated water temperature and the first temperature increase.

14. The temperature determination apparatus of claim 11, wherein the junction temperature determination unit is configured to determine a temperature according to a measurement result of the first temperature sensor as a junction temperature of the second switching element among the junction temperatures.

15. The temperature determination apparatus of claim 11, wherein the junction temperature determination unit is configured to determine a junction temperature of the second switching element among the junction temperatures based on the determined estimated water temperature and the second temperature increase.
